(19) United States
(12) Patent Application Publication
(10) Pub. No.: US 2025/0341717 A1
(43) Pub. Date: Nov. 6, 2025

(54) DISPLAY SYSTEM AND LIGHT EMITTING MODULE THEREOF

(71) Applicant: AUO Corporation, Hsinchu City (TW)

(72) Inventors: Yueh-Heng LEE, Hsinchu City (TW); Chia-Hung CHEN, Hsinchu City (TW)

(21) Appl. No.: 18/979,981

(22) Filed: Dec. 13, 2024

(30) Foreign Application Priority Data
May 3, 2024 (TW) 113116606

(51) Int. Cl. G02B 27/01; F21V 9/40

(52) U.S. Cl. CPC G02B 27/0101; F21V 9/40; G02B 2027/013; G02B 2207/101

(57) ABSTRACT

A display system and a light emitting module are provided. The display system includes a projection surface, a display module and a virtual eye area. The display module generates an image light reflected by the projection surface and generates an image in the virtual eye area. The display module includes the light emitting module having light emitting units arranged in an array. Each light emitting unit has a light shaping unit disposed on a light emitting side of a light source to receive the source light generated by the light source. The source light passes through the light shaping unit to form an emission light field. In a first direction, compared to the light emitting unit closer to a center of the array, the emission light field of the light emitting unit closer to a side edge of the array has a larger light field distribution bias.

### CROSS-REFERENCE TO RELATED PATENT APPLICATION

This non-provisional application claims priority to and the benefit of, pursuant to 35 U.S.C. § 119(a), patent application Ser. No. 11/311,6606 filed in Taiwan on May 3, 2024. The disclosure of the above application is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present disclosure relates to a display system and a light emitting module thereof, and particularly to a head-up display system and a light emitting module thereof.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

With the rapid development of the display technology, the applications thereof have become increasingly diverse and extensive. To enhance user convenience and safety when operating specific devices, such as vehicles, one application of the display technology is the head-up display for drivers.

Traditional in-vehicle head-up displays are often relatively small and provide limited information, such as vehicle speed or other basic indicators. However, with the evolution of car culture and user interface design concepts, the demand for larger display areas in the head-up displays has significantly increased. In addition, since the head-up displays may reduce the frequency and duration of the drivers looking down, they contribute to enhanced driving safety, making the trend towards larger display areas of the head-up displays in the vehicle interface design inevitable.

However, due to external environmental constraints of the head-up displays, such as the thickness, curvature and reflective properties (e.g., special coatings) of the windshield as well as limitations on the driver's seating position and installation location, various considerations are required in the optical design of the head-up displays, and the image quality is often challenged. In addition, as the display area of the head-up displays is required to increase, the image brightness within the display range is not uniform, leading to significant variations and making it difficult and inconvenient for the user to read information.

### SUMMARY

One objective of the present disclosure is to provide a display system, which has relatively uniform image brightness in its display viewing range.

One objective of the present disclosure is to provide a light emitting module, which enhances the brightness uniformity of the combined light field by differentiating the emission light fields of individual light emitting units therein.

In one aspect, a light emitting module includes a plurality of light emitting units arranged in an array. Each light emitting unit has a light source and a light shaping unit. The light shaping unit is disposed on a light emitting side of the light source to receive source light generated by the light source. The source light passes through the light shaping unit to form an emission light field. In a first direction, the emission light field of the light emitting unit closer to a side edge of the array has a larger light field distribution bias compared to the emission light field of the light emitting unit closer to a center of the array. The light field distribution bias may be a lateral shift, a rotation or a combination thereof in the first direction.

In another aspect, a display system includes a projection surface, a display module and a virtual eye area. The display module includes the light emitting module array. The display module is disposed corresponding to the projection surface and generates an image light reflected by the projection surface and at least generates an image in the virtual eye area. Light of the emission light fields of the light emitting units are reflected by the projection surface to collectively form a global range corresponding to the virtual eye area, and the light of each of the mission light fields of the light emitting units is reflected by the projection surface to form a unit band range in the global range. At least some of the unit band ranges has an area distribution bias relative to other unit band ranges. The area distribution bias may be a lateral shift, a rotation or a combination thereof in the first direction.

In another aspect, a display system includes a projection surface and a curved display module. The projection surface is a curved surface and is oblique relative to a viewing direction. The projection surface has a first cross-section on a second virtual plane perpendicular to the viewing direction, and the first cross-section has a first curvature. The curved display module is disposed corresponding to the projection surface and generates an image light reflected by the projection surface and at least generates an image in the viewing direction. The curved display module has a second cross-section on the second virtual plane, and the second cross-section has a second curvature. The first cross-section and the second cross-section respectively recess toward directions away from each other, and the first curvature is greater than the second curvature.

These and other aspects of the present disclosure will become apparent from the following description of the embodiment taken in conjunction with the following drawings, detailed description and the claims.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIGS. 1A and 1B are schematic views of a display system according to one embodiment of the present disclosure.

FIG. 2A is a schematic view of a display system according to one embodiment of the present disclosure.

FIG. 2B is a schematic view of a display module of a display system according to one embodiment of the present disclosure.

FIG. 3 is a schematic view of a light emitting module according to one embodiment of the present disclosure.

FIG. 4 is a schematic view of an emission light field according to one embodiment of the present disclosure.

FIG. 5A is a schematic view of an emission light field bias according to one embodiment of the present disclosure.

FIG. 5B is a schematic view of an emission light field bias according to another embodiment of the present disclosure.

FIG. 5C is a schematic view of an emission light field bias according to another embodiment of the present disclosure.

FIG. 6 is a schematic view of the corresponding relationship of the light emitting units and the emission light fields of the light emitting module according to one embodiment of the present disclosure.

FIG. 7 is a schematic view of a light shaping unit array according to one embodiment of the present disclosure.

FIG. 8 is a schematic view of the geometric relationship between adjacent light shaping units according to one embodiment of the present disclosure.

FIG. 9 is a schematic view of a light shaping unit array according to another embodiment of the present disclosure.

FIG. 10 is a schematic view of a light shaping unit according to one embodiment of the present disclosure.

FIG. 11 is a schematic view of a light shaping unit according to another embodiment of the present disclosure.

FIG. 12A is a schematic view of a display system according to one embodiment of the present disclosure.

FIG. 12B is a schematic view of the relative relationship of the unit band ranges corresponding to the light emitting units and the global range according to one embodiment of the present disclosure.

FIG. 13 is a schematic view of a display system according to another embodiment of the present disclosure.

FIG. 14 is a schematic view of a display module according to another embodiment of the present disclosure.

### DETAILED DESCRIPTION

Implementations of a display module disclosed in the present disclosure are described through specific embodiments and accompanying drawings as follows. Those skilled in the art can understand the advantages and effects of the present disclosure based on the content disclosed in the specification. However, the following disclosures are not intended to limit the scope of protection of the disclosure. Under principles that do not deviate from the spirit of the present disclosure, those skilled in the art may implement the disclosure in other different embodiments based on various perspectives and applications.

In the accompanying drawings, to clearly show the components, the thicknesses of the layers, films, panels and areas, etc. are enlarged. In the disclosure, identical drawing references indicates identical components. It should be understood that components such as the layers, films, panels and areas, etc., are referred to as being “on” or “connected to” another component, they may be on or connected to another component directly, or an intermediate component may exist therebetween. To the contrary, when a component is referred to as being “directly on” or “directly connected to” another component, there is no intermediate component therebetween. As used herein, being “connected” may refer to physical connection or electrical connection.

It should be understood that terms such as “first”, “second”, and “third” are used to describe various elements, components, regions, layers and/or portions herein. However, these elements, components, regions, layers and/or parts should not be limited by these terms. These words are only used for distinguishing between an element, a component, a region, a layer and/or a part from another element, component, region, layer and/or portion. Therefore, a first “element”, “component”, “region”, “layer” and/or “portion” hereinafter may also be referred to as a second “element”, “component”, “region”, “layer” and/or “portion” without departing from the concept of the present disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” when used in this specification, specify the presence of stated features, regions, integers, steps, operations, elements, and/or components, but do not preclude the presence or addition of one or more other features, regions, integers, steps, operations, elements, components, and/or groups thereof.

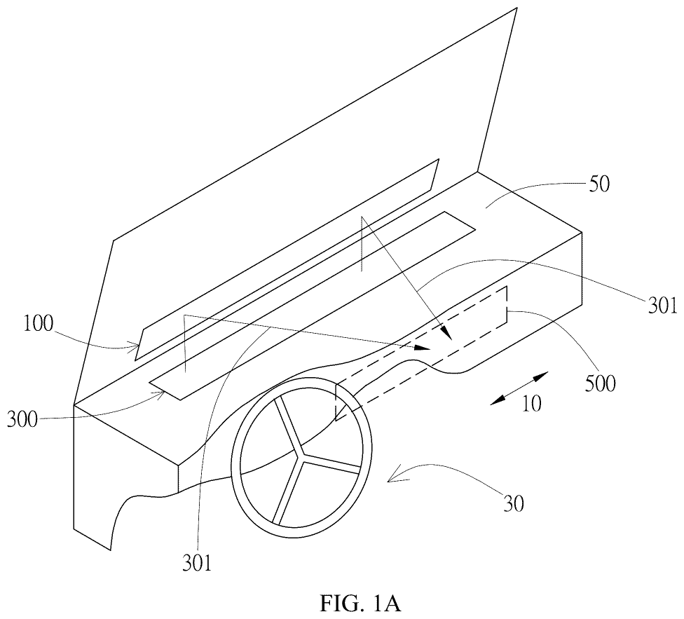

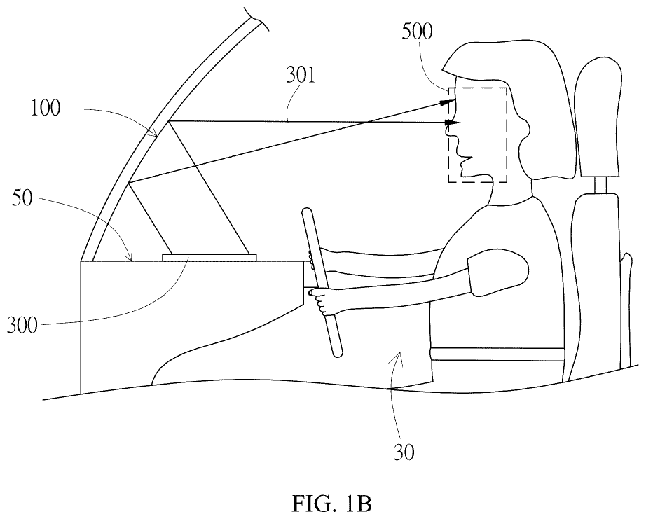

The present disclosure relates to a display system and a light emitting module thereof. In one embodiment, the display system is used in vehicles, other transportation devices or other devices that require user operation, and functions as a head-up display. In addition, the display system of the present disclosure is also suitable for near-eye displays or other projection-based display devices. In one embodiment as shown in FIGS. 1A and 1B, the display system includes a projection surface 100, a display module 300 and a virtual eye area 500. In an embodiment where the display system is disposed in a vehicle, the projection surface 100 may be, for example, the windshield of the vehicle, but is not limited thereto. In addition, the projection surface 100 may be a portion of the windshield, such as a band-shaped area near the lower end of the windshield. The display module 300 is disposed at an angle with respect to the projection surface 100, for example, an acute angle between 0 and 90 degrees. In the embodiment as shown in FIGS. 1A and 1B, the display module 300 is disposed on the top 50 of the instrument panel and the control console of the vehicle. As shown in FIGS. 1A and 1B, the display module 300 extends and is distributed along a first direction 10, which may be, for example, a long side direction of the projection surface 100, or an extending direction of the intersection between the projection surface 100 and the top of the instrument panel and the control console. When the display system is disposed in a vehicle, the first direction 10 may also be a width direction of the vehicle perpendicular to a forward direction of the vehicle.

As shown in FIGS. 1A and 1B, the vehicle or other device in which the display system is disposed has a cabin 30 for a driver or other users. When the driver or other users are located within the cabin 30, their eyes will be confined to a certain spatial range due to their sitting, standing, or other postures. The spatial range is an exemplary definition of the virtual eye area 500. Thus, although the virtual eye area 500 is not a physical device or structure, it serves as an imaging reference area for the image design of the display system. For example, the reference area may be provided by the vehicle manufacturer to the head-up display designer, and may be defined by the control design of the cabin 30 of the vehicle or other device and the predetermined ergonomic design of the driver/user. Since the cabin design takes into account the possible movement range and different body sizes of the user, the virtual eye area 500 may form a band-shaped or columnar range with a relatively long length in the first direction 10. Specifically, for example, the possible position range of the eyes of a user with a height between 150 cm and 190 cm when sitting in a seat may be estimated to obtain an embodiment of the virtual eye area 500.

As shown in FIGS. 1A and 1B, the display module 300 is disposed relative to the projection surface 100, such that the image light 301 generated by the display module 300 may be projected onto the projection surface 100 and reflected by the projection surface 100 to at least generate an image in the virtual eye area 500. Preferably, the image observed by the driver/user in the virtual eye area 500 is a virtual image generated by the reflection of the image light 301 from the projection surface 100.

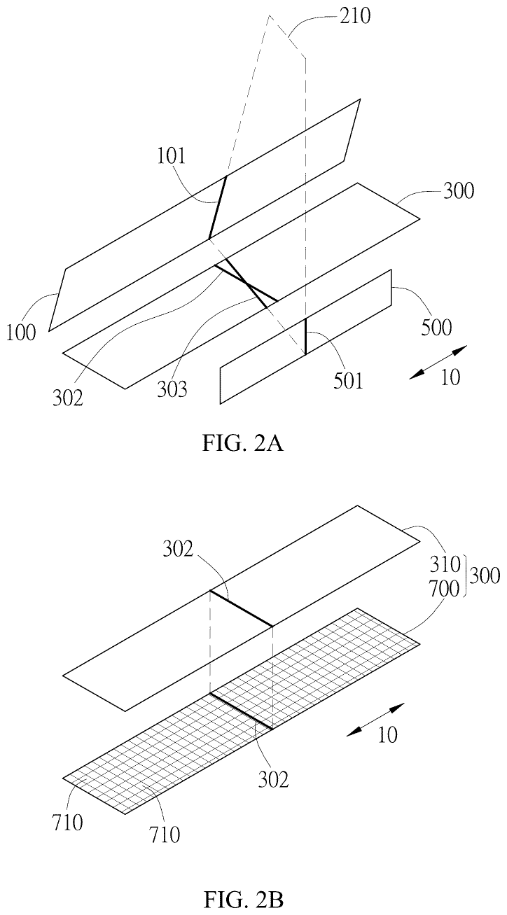

In addition, in the present embodiment, as shown in FIG. 2A, the virtual eye area 500 has a first upright central axis 501 in a direction substantially upright relative to the ground; and the projection surface 100 also has a second upright central axis 101 in a direction substantially upright relative to the ground. In the present embodiment, the term “upright” herein is not limited to the vertical direction but includes other non- vertical orientations that are not parallel to the ground and form a non-right angle with the ground. The first upright central axis 501 and the second upright central axis 101 collectively form a first virtual plane 210, and an intersection line 303 between the first virtual plane 210 and the display module 300 has a midpoint. The midpoint extends in a direction perpendicular to the first direction 10 and parallel to the display module 300 to form a symmetry axis 302 of the display module 300.

FIG. 2B is a schematic view of a display module of a display system according to one embodiment of the present disclosure. In the present embodiment, the display module 300 includes a display panel 310 and a backlight module 330. The display panel 310 may be, for example, a liquid crystal display panel, and is disposed on a light emitting side of the backlight module 330. After the light generated by the backlight module 330 reaches the display panel 310, the light is modulated by the display panel 310 to generate the image light 301. In the present embodiment, the backlight module 330 includes a light emitting module 700, and the light emitting module 700 includes a plurality of light emitting units 710. The light emitting units 710 are arranged in an array, such as a checkerboard-type row-column pattern, a hexagonal close packing pattern or other arrangement patterns. In the embodiment as shown in FIG. 2B, the array of the light emitting units 710 extends along the first direction 10. In addition, the light emitting units 710 are mirror-image distributed relative to the symmetry axis 302 of the display module 300, such that the output light field has good brightness uniformity within the range of the virtual eye area 500.

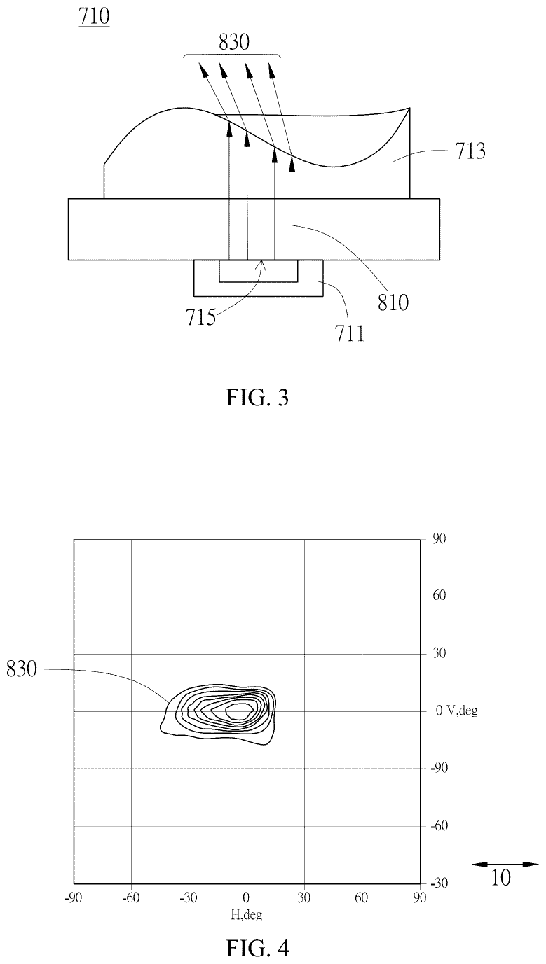

As shown in FIG. 3, each light emitting unit 710 has a light source 711 and a light shaping unit 713. The light source 711 is preferably a light emitting diode and has a light emitting surface 715. The light shaping unit 713 is disposed to correspond to the light emitting side of the light source 711, that is, opposite to the light emitting surface 715, to receive the source light 810 generated by the light source 711. The light shaping unit 713 may be, for example, a lens or an optical film, which may refract, scatter, or otherwise modify the path of the source light 810 received to adjust the emission angle and/or the distribution range.

As shown in FIG. 4, the source light 810 passes through the light shaping unit 713 to form an emission light field 830. Specifically, after the source light 810 passes through the light shaping unit 713, the observed light field profile of the source light 810 forms a distribution with a specific contour. In certain embodiments, the contour may be a band shape with its long side extending in a straight line, an arc, or an irregular curve. In addition, in certain embodiments, the observation of the light field profile of the emission light field 830 may be based on a lower limit of 50% or 30% of the maximum light field intensity or other different standards. In other words, all light in the range within the lower limit of the observed light field profile being set may be included for evaluating the contour of the light field profile. In another embodiment, it is also possible not to set a lower limit of the light intensity for the observed light field profile, and all observed light are included in the evaluation of the contour of the light field profile.

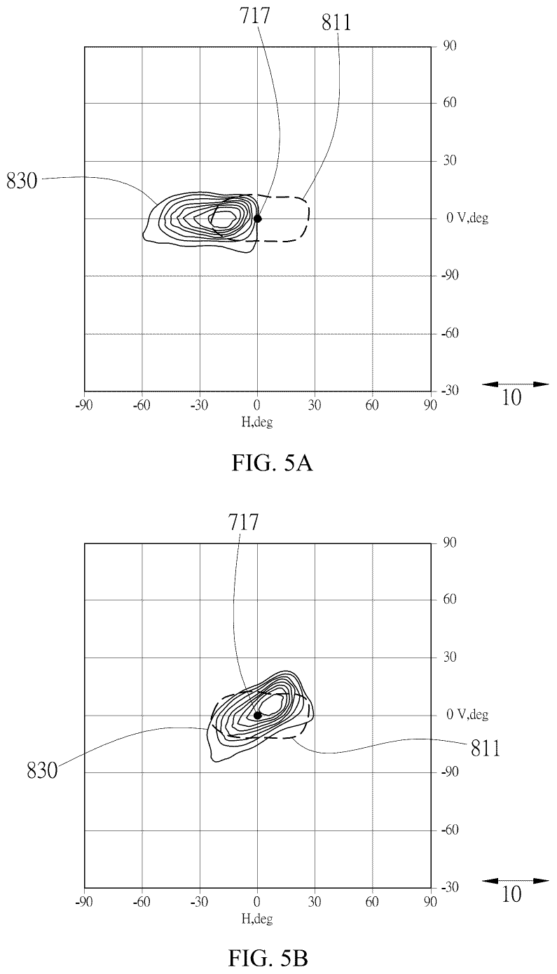

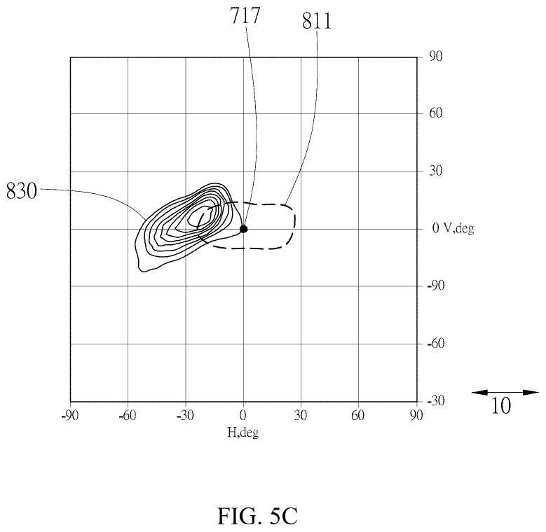

As shown in FIG. 5A, the emission light field 830 formed by the light shaping unit 713 has a light field distribution bias relative to the light field 811 of the source light 810. In the present embodiment, the bias may be, for example, a lateral shift of a central line of the contour of the emission light field 830 relative to a center of the light field 811 of the source light 810 or a normal 717 of a light emitting surface of the light source 717 in the first direction 10. However, in different embodiments, as shown in FIG. 5B, the bias may be a rotation of a long direction of the emission light field 830 relative to the first direction 10. In the embodiment as shown in FIG. 5C, the bias may be the lateral shift and the rotation simultaneously occurring in the emission light field 830.

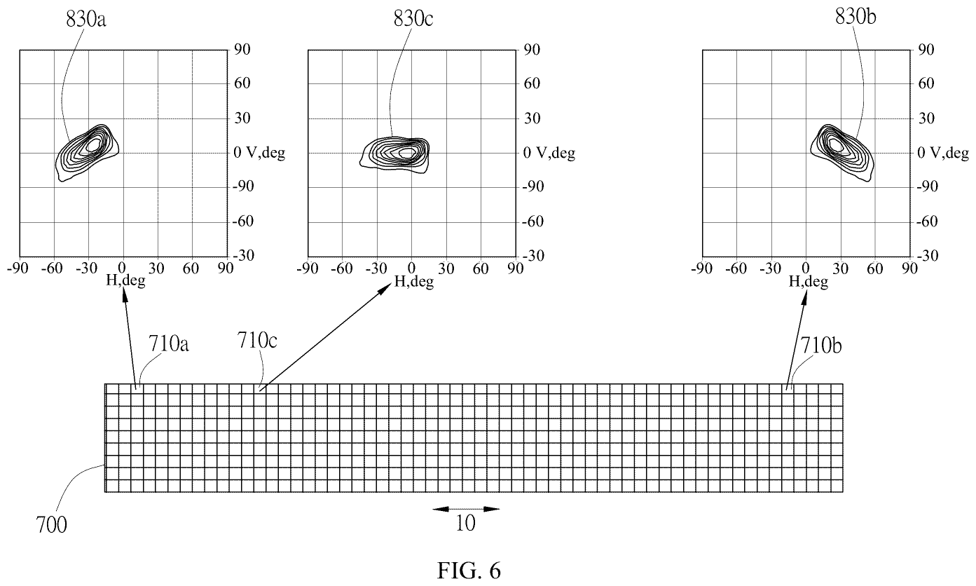

In the embodiment as shown in FIG. 6, the light emitting unit 710a is located at a location toward the left in the first direction 10 within the entire light emitting unit array, and the emission light field 830a generated by the corresponding light shaping unit 713a exhibits a leftward lateral shift and/or a counterclockwise rotation in the first direction 10. In contrast, the light emitting unit 710b is located at a location toward the right in the first direction 10 within the entire light emitting unit array, and the emission light field 830b generated by the corresponding light shaping unit exhibits a rightward lateral shift and/or a clockwise rotation in the first direction 10.

In addition, as shown in FIG. 6, compared to the light emitting unit 710c located at the same side but closer to a center of the entire light emitting unit array, the emission light field 830a of the light emitting unit 810a located closer to a side edge of the array in the first direction 10 has a larger light field distribution bias. For the light emitting unit 710 located at center of the array, the emission light field 830 thereof may have no light field distribution bias or may have a slight light field distribution bias.

By generating biases and offsetting the emission light fields 830 of the individual light emitting units 710 as described above, the overall brightness distribution of the combined emission light fields 830 becomes more uniform, thereby achieving a more uniform image brightness within the entire viewing area of the display system, preventing from excessively low brightness in certain image areas, which may degrade the visual experience for the user.

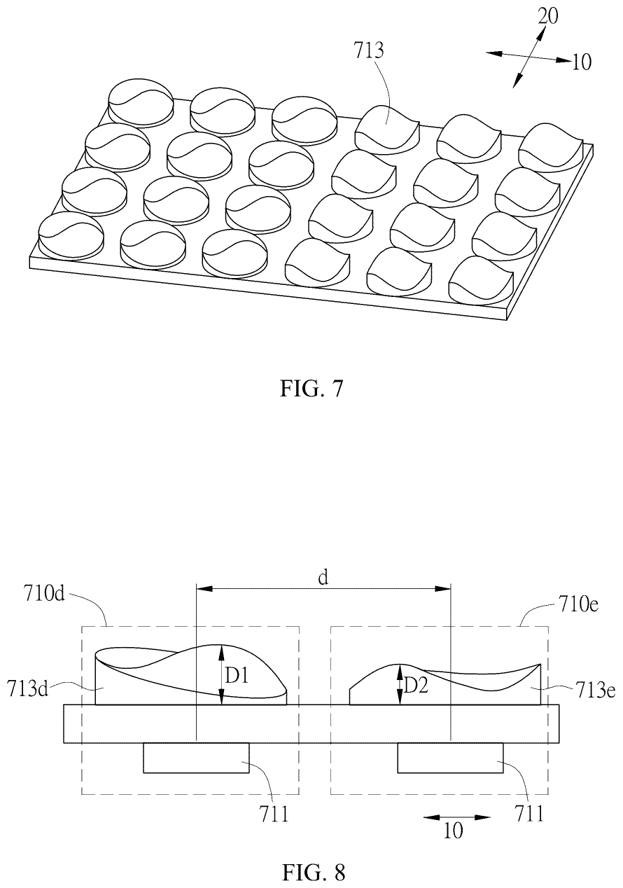

As shown in FIG. 7, the light shaping unit 713 includes a lens disposed on the light source 711. The light emitting surface of the lens may be a freeform curved surface or a curved surface defined by a polynomial function based on geometric parameters. In one embodiment, multiple lenses arranged along the first direction 10 exhibit a gradual variation in the geometric properties of their light emitting surfaces, such as the maximum curvature and the maximum height difference between the highest and lowest points of the curved surface, etc. Preferably, the gradual variation results in the lenses closer to the center of the array having smaller values of the geometric parameters of the curved surface, and those closer to the two ends thereof having larger values of the geometric parameters of the curved surface. In contrast, the lenses arranged along the second direction 20, e.g., the direction extending from the front to the rear of a vehicle, which is perpendicular to the first direction 10, exhibit no significant variation or no variation in the geometric properties of their light emitting surfaces.

In the embodiment as shown in FIG. 8, the adjacent light emitting units 710d and 710e arranged in the first direction 10 respectively have a first lens 713d and a second lens 713e. The first lens 713d has a first thickness D1, and the second lens 713e has a second thickness D2. D1 and D2 meet the following relationship:

$$\frac{\vert D 1 - D 2 \vert}{D 1} < 0.15 .$$

In another embodiment, the first lens 713d and the second lens 713e have a central distance d therebetween, and D1, D2 and d meet the following relationship:

$$\frac{\vert D 1 - D 2 \vert}{d} < 0.26 .$$

With the design as described above, the requirement of offsetting the emission light fields to create differentiation may be met, without excessive differences that may be easily perceived by the user. In addition, the aforementioned constraints on the geometric parameters of the lens allow for simultaneously maintaining high manufacturing yield and improving process efficiency.

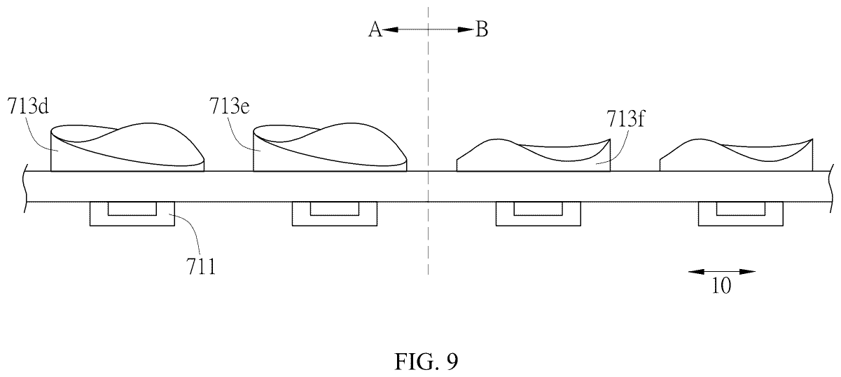

In the embodiment as shown in FIG. 8, the lenses adjacent in the first direction 10 have different curvature geometries. However, in another embodiment, as shown in FIG. 9, the lenses arranged in the first direction 10 may be divided into a plurality of sections in the first direction 10, and the lenses in the same section may have identical curvature geometry and other geometric parameters. For example, the first lens 713d and the second lens 713e arranged in the first direction 10 both belong to the section A, and the curvature geometry and other geometric parameters such as thickness, etc. of both are identical. The third lens 713f is located in the section B, which is different from the first lens 713d and the second lens 713e, and the third lens 713f has a different curvature geometry and different other geometric parameters from those of the first lens 713d and the second lens 713e.

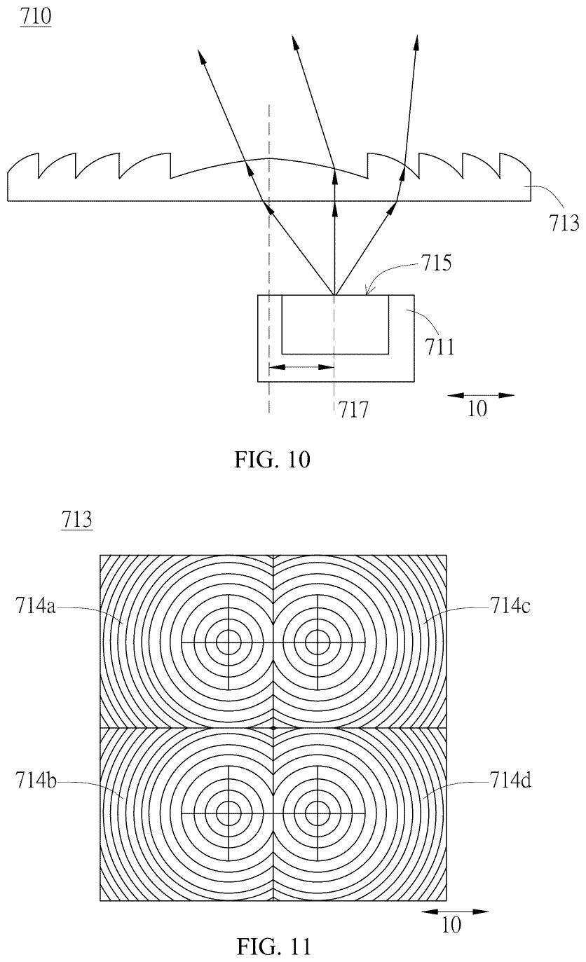

FIG. 10 is a schematic view of a light shaping unit 713 according to another embodiment of the present disclosure. In the present embodiment, the light shaping unit 713 includes a Fresnel lens or a part of the Fresnel lens. A center of the Fresnel lens deviates from a central normal 717 of a light emitting surface 715 of the light source 711, such as generating a lateral shift from a center of the light emitting surface 715 in the first direction 10. The light emitting unit 710 having a greater distance from the center of the array in the first direction 10 may have a greater deviation between the center of the lens and the center of the light emitting surface 715.

In another embodiment, as shown in FIG. 11, a single light shaping unit 713 may include a plurality of unit lenses 714a, 714b, 714c and 714d. The unit lenses 714a, 714b, 714c and 714d may all be Fresnel lenses or at least some of them are unit lenses 714a, 714b, 714c and 714d. In the present embodiment, at least some of the unit lenses 714a and 714b have deviation directions different from the deviation directions of other unit lenses 714c and 714d in the same light shaping unit 713. For example, the unit lenses 714a and 714b that are adjacent vertically both deviate rightward, and the unit lenses 714c and 714d located at the right side of the unit lenses 714a and 714b both deviate leftward. With this configuration, the contour shape of specific portions of the emission light field 830 may be finely adjusted by adjusting the deviation directions of the individual unit lenses.

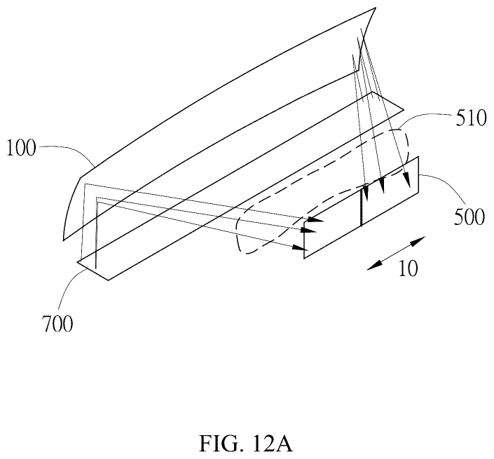

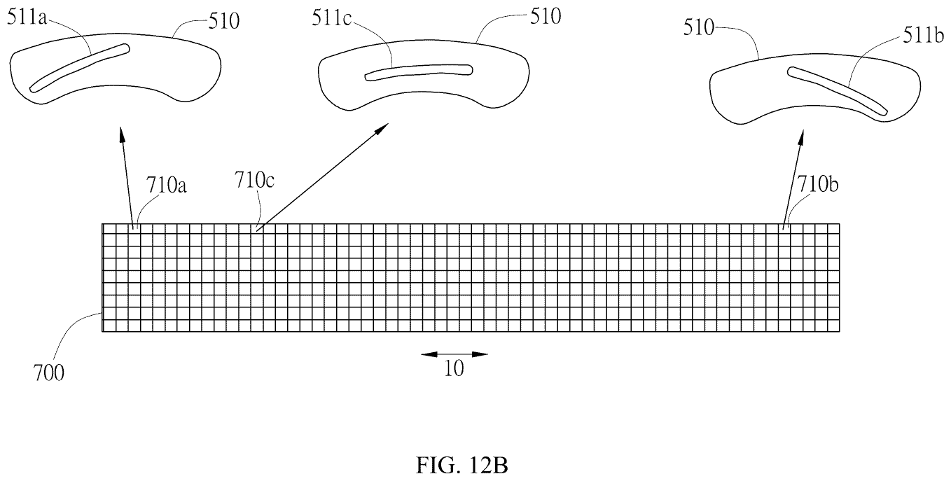

As shown in FIGS. 12A and 12B, in the light emitting module 700, the light of the emission light fields 830 of all of the light emitting units 710 are reflected by the projection surface 100 to collectively form a global range 510 corresponding to the virtual eye area 500. Specifically, the global range 510 refers to the maximum range of field of view from the positions within the virtual eye area 500 where all emission light fields 830 reflected by the projection surface 100 may be observed. The light of each mission light field 830 is reflected by the projection surface 100 to form a unit band range 511 in the global range 510. That is, a range of the virtual image formed by the light of the emission light field 830 of a light emitting unit 710 observed from various positions within the virtual eye area 500 is the corresponding unit band range 511. In various embodiments, the long edge of the unit band range 511 may have an extending direction in a straight line, an arc, or an irregular curve. For example, in the embodiment as shown in FIGS. 12A and 12B, the global range is in a curved band shape. In addition, in various embodiments, the observation of the field profile of the unit band range 511 may be based on a lower limit of 50% or 30% of the maximum light field intensity or other different standards. In other words, all light in the range within the lower limit of the observed field profile being set may be included for evaluating the contour of the light field profile. In another embodiment, it is also possible not to set a lower limit of the light intensity for the observed field profile, and all observed light are included in the evaluation of the contour of the field profile.

As shown in FIG. 12B, at least some of the unit band ranges 511a and 511b have an area distribution bias relative to other unit band ranges 511c. In the present embodiment, the bias may be, for example, a lateral shift of the unit band range 511a relative to the unit band range 511c within the global range 510 in the first direction 10. However, the bias may be a rotation of a long direction of the unit band range 511a relative to the first direction 10 being greater than a rotation of a long direction of the unit band range 511c relative to the first direction 10. In another embodiment, the bias may be the lateral shift and the rotation simultaneously occurring as described above.

In the embodiment as shown in FIG. 12B, the light emitting unit 710a is located at a position toward the left in the first direction 10 within the entire light emitting unit array, and the corresponding unit band range 511a exhibits a leftward lateral shift and/or a counterclockwise rotation in the first direction 10. In contrast, the light emitting unit 710b is located at a location toward the right in the first direction 10 within the entire light emitting unit array, and the corresponding unit band range 511b exhibits a rightward lateral shift and/or a clockwise rotation in the first direction 10.

In addition, as shown in FIG. 12B, compared to the light emitting unit 710c located at the same side but closer to the center of the entire light emitting unit array, the corresponding unit band range 511a of the light emitting unit 810a located closer to a side edge of the array in the first direction 10 has a larger area distribution bias. For the light emitting unit 710 located at center of the array, the unit band range 511 thereof may have no area distribution bias or may have a slight area distribution bias.

By generating biases and offsetting the corresponding unit band ranges 511 of the light emitting units 710 as described above, the overall brightness distribution of the global range 510 by combining the unit band ranges 511 becomes more uniform, thereby achieving a more uniform image brightness within the entire viewing area of the display system, preventing from excessively low brightness in certain image areas, which may degrade the visual experience for the user.

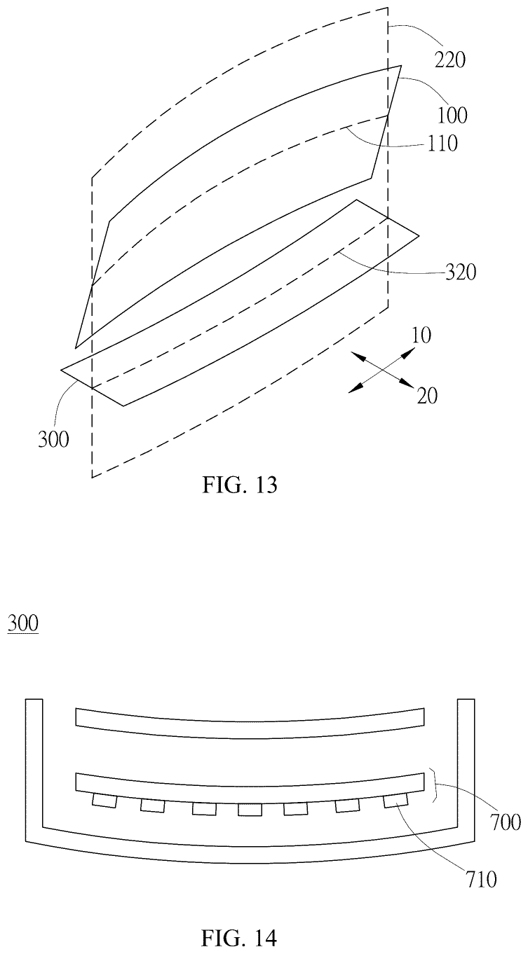

FIG. 13 is a schematic view of a display system according to another embodiment of the present disclosure. In the present embodiment, the projection surface 100 is a concave curved surface, such as an inwardly concave hyperboloid, and is oblique relative to the viewing direction (e.g., the second direction 20). The projection surface 100 has a first cross-section 110 on a second virtual plane 220 perpendicular to the second direction 20, and the first cross-section 110 has a first curvature. In addition, the display module 300 is a curved display module, and its display surface is also a curved surface. The display module 300 also has a second cross-section 320 on the second virtual plane 220, and the second cross-section 320 has a second curvature. As shown in FIG. 13, the first cross-section 110 and the second cross-section 320 respectively recess toward directions away from each other, and the first curvature is greater than the second curvature. In one embodiment, the second curvature is substantially 50% of the first curvature, but is not limited thereto. Through the design where the first curvature is greater than the second curvature, the width (H direction) and the height (V direction) of the global range 511 may be reduced, thus significantly reducing the design difficulty of the light shaping unit 713, with an effect of 50% being preferable.

FIG. 14 is a schematic view of a display module 300 on the second cross-section 320. As shown in FIG. 14, the backlight module 330 of the display module 300 has a light emitting module 700 formed by a plurality of light emitting units 710. The formation of the light emitting units 710 may be referenced to based on the aforementioned embodiments, and is thus not hereinafter reiterated. In the present embodiment, the light emitting units 710 may be arranged in a concave manner, such as being arranged to have a distribution on the second cross-section 320 with the second curvature. With this arrangement, the corresponding unit band range 511 of each light emitting unit 710 may have a more regular contour range, reducing the degree of irregularity. Therefore, when the unit band ranges 511 are combined to form the global range 510, the brightness of the image formed may also be more uniform, thus reducing the occurrence of excessive brightness or darkness. In addition, since the light emitting units 710 are also distributed in an curved manner, the light fields generated by them may reduce the optical complexity originally caused by the curvature of the projection surface 100, thereby obtaining a more controllable image.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A light emitting module, comprising:
a plurality of light emitting units, arranged in an array, wherein each of the light emitting units has:
a light source, generating a source light; and
a light shaping unit, disposed on a light emitting side of the light source to receive the source light, wherein the source light passes through the light shaping unit to form an emission light field;
wherein in a first direction, the emission light field of the light emitting unit closer to a side edge of the array has a larger light field distribution bias compared to the emission light field of the light emitting unit closer to a center of the array.

2. The light emitting module according to claim 1, wherein the light field distribution bias comprises a lateral shift of a central line of the emission light field relative to a normal of a light emitting surface of the light source.

3. The light emitting module according to claim 1, wherein the light field distribution bias comprises a rotation of a long direction of the emission light field relative to the first direction.

4. The light emitting module according to claim 1, wherein the light shaping unit comprises a lens.

5. The light emitting module according to claim 4, wherein adjacent ones of the light emitting units arranged in the first direction respectively have a first lens and a second lens, the first lens has a first thickness D1, the second lens has a second thickness D2, and D1 and D2 meet the following relationship:
$$\frac{\vert D 1 - D 2 \vert}{D 1} < 0.15 .$$

6. The light emitting module according to claim 4, wherein adjacent ones of the light emitting units arranged in the first direction respectively have a first lens and a second lens, the first lens has a first thickness D1, the second lens has a second thickness D2, the first lens and the second lens have a central distance d therebetween, and D1, D2 and d meet the following relationship:
$$\frac{\vert D 1 - D 2 \vert}{d} < 0.26 .$$

7. The light emitting module according to claim 4, wherein the lenses of the light emitting units adjacent in the first direction have different curvature geometries.

8. The light emitting module according to claim 4, wherein the lenses of the light emitting units comprise a first lens, a second lens and a third lens arranged in the first direction, and the first lens and the second lens have an identical curvature geometry and the third lens has a different curvature geometry.

9. The light emitting module according to claim 1, wherein the light shaping unit comprises a Fresnel lens, and a center of the Fresnel lens deviates from a center of a light emitting surface of the light source.

10. The light emitting module according to claim 1, wherein the light shaping unit comprises a plurality of unit lenses, and at least some of the unit lenses has a bias direction different from bias directions of others of the unit lenses of the same light shaping unit.

11. A display system, comprising:
a projection surface;
a display module, comprising the light emitting module according to claim 1; and
a virtual eye area;
wherein the display module is disposed corresponding to the projection surface and generates an image light reflected by the projection surface and at least generates an image in the virtual eye area.

12. The display system according to claim 11, wherein the virtual eye area has a first upright central axis, the projection surface has a second upright central axis, the first upright central axis and the second upright central axis collectively form a first virtual plane, an intersection line of the first virtual plane and the display module has a midpoint, the midpoint extends along a direction perpendicular to the first direction and parallel to the display module to form a symmetry axis of the display module, and the light emitting units are mirror-image symmetrically distributed relative to the symmetry axis.

13. The display system according to claim 11, wherein light of the emission light fields of the light emitting units are reflected by the projection surface to collectively form a global range corresponding to the virtual eye area, the light of each of the mission light fields of the light emitting units is reflected by the projection surface to form a unit band range in the global range, and at least some of the unit band ranges has an area distribution bias relative to other unit band ranges.

14. The display system according to claim 13, wherein the area distribution bias comprises a movement bias along the first direction.

15. The display system according to claim 13, wherein the area distribution bias comprises a rotation of a long direction of the unit band range relative to the first direction.

16. A display system, comprising:
a projection surface, wherein the projection surface is a curved surface and is oblique relative to a viewing direction, the projection surface has a first cross-section on a second virtual plane perpendicular to the viewing direction, and the first cross-section has a first curvature; and
a curved display module, disposed corresponding to the projection surface and generates an image light reflected by the projection surface and at least generates an image in the viewing direction, wherein the curved display module has a second cross-section on the second virtual plane, and the second cross-section has a second curvature;
wherein the first cross-section and the second cross-section respectively recess toward directions away from each other, and the first curvature is greater than the second curvature.

17. The display system according to claim 16, wherein the curved display module comprises a curved display panel and a backlight module, the backlight module comprises a light emitting module, and the light emitting module comprises:
a plurality of light emitting units, arranged in an array, wherein each of the light emitting units has:
a light source, generating a source light; and
a light shaping unit, disposed on a light emitting side of the light source to receive the source light, wherein the source light passes through the light shaping unit to form an emission light field;
wherein in a first direction, the emission light field of the light emitting unit closer to a side edge of the array has a larger light field distribution bias compared to the emission light field of the light emitting unit closer to a center of the array.

18. The display system according to claim 17, wherein an arrangement of the light emitting units of the light emitting module has the second curvature on the second cross-section.

19. The display system according to claim 16, wherein the second curvature is substantially 50% of the first curvature.
